(19) United States
(12) Patent Application Publication
(10) Pub. No.: US 2016/0363986 A1
(43) Pub. Date: Dec. 15, 2016

(54) FAST LINK WAKE-UP IN SERIAL-BASED IO FABRICS

(71) Applicant: Samsung Electronics Co., Ltd., Suwon-si (KR)

(72) Inventors: Ian SWARBRICK, Santa Clara, CA (US); Michael BEKERMAN, Los Gatos, CA (US); Rohit NATARAJAN, Bangalore (IN)

(21) Appl. No.: 14/735,119

(22) Filed: Jun. 9, 2015

(51) Int. Cl. G06F 1/32; G06F 1/26; G06F 13/42

(52) U.S. Cl. CPC G06F 1/3296; G06F 13/4282; G06F 1/266

(57) ABSTRACT

A system and a method select a datapath through a meshed Input/Output (IO) fabric. A plurality of port controllers is coupled to interconnection logic. Each port controller is coupled to a corresponding communication link and outputs a detection signal if the corresponding communication link transitions from a first lower-power state to a second higher power state. The interconnection logic, responsive to the detection signal, is configured to output a first signal to one or more selected port controllers to transition the corresponding communication link coupled to the selected port controller from the first power state to the second power state based on a frequency of use of a datapath between the communication link corresponding to the port controller outputting the detection signal and the communication link corresponding to each of the one or more selected port controllers.

### BACKGROUND

The Peripheral Component Interconnect (PCI) Express (PCIe) standard includes Active State Power Management (ASPM) considerations to reduce system energy consumption. With ASPM, a PCIe link, which is a high-speed point-to-point link, can take on one of several power states: L0, L0s, L1.0, L1.1, L1.2, L2 and L3. The L0 power state is a normal, fully active operating state that uses the highest amount of energy of the several power states. The L0s power state is a standby energy-saving state having a fast transition time to the L0 power state. The L1.0 power state is a standby-power state that is lower power than the L0s power state, and has a longer transition time to the L0 power state than that of the L0s power state. The L1.1 power state is a still lower power state, and has a still longer transition time to the L0 power state. The L1.2 power state is an even lower power state than the L1.1 power state, and has a correspondingly longer transition time to the L0 power state. The L2 power state is an auxiliary-powered deep-energy-saving state, and the L3 power state is a link off state. The L2 and L3 states are not supported by ASPM, and are only supported by software-driven PCI-PM (i.e., Power Management by driver).

One PCIe general practice is that when an active link becomes idle for a specified period of time, the link can enter a lower power state(s) following configured ASPM criteria. Using a link that is not in the L0 power state requires transitioning the link to the L0 state, which potentially requires a link-retraining phase, and always incurs a transition delay having a duration that increases with increasing power-saving states.

The increasingly lower-power states beyond the L0 power state require increasingly longer times (i.e., greater latency) to transition to the L0 state in order to perform data-transfer operations. In practice, the transition times degrade PCIe throughput performance because a PCIe bus can only transfer data in L0 state. Thus, there are tradeoffs between PCIe performance and electrical power savings.

The PCIe standard does not define a mechanism to propagate wake-up information beyond a link that is transitioning to the L0 power state. Additionally, for multiple datapaths, the PCIe standard does not provide a mechanism to determine which datapaths of a multi-datapath configuration should wake up and transition to the L0 power state. Waking all links using the PCIe standard technique would consume a significant amount of power and waking up each controller along on a datapath when the controller receives a packet in accordance with the PCIe standard would be slow, and each link would need to retrain, which would take an excessive amount of time.

### SUMMARY

Embodiments disclosed herein provide a system and a method to select a datapath through a meshed Input/Output (IO) fabric. A plurality of port controllers is coupled to interconnection logic. Each port controller is coupled to a corresponding communication link and outputs a detection signal if the corresponding communication link transitions from a first lower-power state to a second higher power state. The interconnection logic, in response to the detection signal, is configured to output a wake-up signal to one or more selected port controllers to transition the corresponding communication link coupled to the selected port controller from the first power state to the second power state based on a frequency of use of a datapath between the communication link corresponding to the port controller outputting the detection signal and the communication link corresponding to each of the one or more selected port controllers.

Embodiments disclosed herein provide a System on a Chip (SoC), comprising: a plurality of port controllers and interconnection logic. Each port controller is coupled to a corresponding communication link and each port controller is configured to output a detection signal if the corresponding communication link transitions from a first power state to a second power state in which the first power state is a lower power state than the second power state. The interconnection logic is coupled to each port controller and is configured to be responsive to the detection signal of each port controller by outputting a first signal to one or more selected port controllers to transition the corresponding communication link coupled to the selected port controller from the first power state to the second power state.

In one exemplary embodiment, the one or more selected port controllers are selected based on a datapath between the communication link corresponding to the port controller outputting the detection signal and the communication link corresponding to each of the one or more selected port controllers. In one exemplary embodiment, the one or more selected port controllers are selected based on a frequency of use of the datapath between the communication link corresponding to the port controller outputting the detection signal and the communication link corresponding to each of the one or more selected port controllers. In one exemplary embodiment, the interconnection logic comprises a table containing information relating to the datapath for selecting the one or more port controllers.

In one exemplary embodiment, the communication link coupled to at least one port controller comprises a Peripheral Component Interconnect Express (PCIe) communication link. In one exemplary embodiment, the first power state comprises an L1.0, an L1.1 or an L1.2 power state, and the second power state comprises an L0 power state. In one exemplary embodiment, each port controller comprises a Root Complex (RC) or an End Point (EP). In one exemplary embodiment, the communication links comprise Serializer/Deserializer (SERDES) links.

Some exemplary embodiments provides that the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.

Embodiments disclosed herein provide a system that comprises a plurality of communication links and a plurality of Systems of a Chip (SoCs) interconnected by the plurality of communication links. The one or more of the communication links comprise a first power state and a second power state in which the first power state is a lower power state than the second power state, and the one or more communication links transition from the first power state to the second power state to transport data over the communication link. Each SoC comprises at least two port controllers and interconnection logic. Each port controller is coupled to a corresponding communication link, and the at least two port controllers are configured to output a detection signal if the corresponding communication link transitions from the first power state to the second power state. The interconnection logic is coupled to the at least two port controllers, and is configured to be responsive to the detection signal of the at least one of the two port controllers by outputting a first signal to one or more selected port controllers to transition the corresponding communication link coupled to the selected port controller from the first power state to the second power state.

In one exemplary embodiment, the one or more selected port controllers are selected based on a datapath between the communication link corresponding to the port controller outputting the detection signal and the communication link corresponding to each of the one or more selected port controllers. In one exemplary embodiment, the one or more selected port controllers are selected based on a frequency of use of the datapath between the communication link corresponding to the port controller outputting the detection signal and the communication link corresponding to each of the one or more selected port controllers. In one exemplary embodiment, the interconnection logic comprises a table containing information relating to the datapath for selecting the one or more port controllers.

In one exemplary embodiment, the communication link coupled to at least one port controller comprises a Peripheral Component Interconnect Express (PCIe) communication link. In one exemplary embodiment, the first power state comprises an L1.0, an L1.1 or an L1.2 power state, and the second power state comprises an L0 power state. In one exemplary embodiment, each port controller comprises a Root Complex (RC) or an End Point (EP).

In one exemplary embodiment, the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.

Embodiments disclosed herein provide a method to select a datapath through a meshed Input/Output (IO) fabric comprising: detecting at a first port controller a transition from a first power state to a second power state of a communication link coupled to the port controller in which the first power state is a lower power state than the second power state; and determining in response to the detection of the transition of the communication link from the first power state to the second power state one or more second port controllers to be notified of the transition of the communication link coupled to the second power state.

In one exemplary embodiment, the one or more second port controllers are determined based on a frequency of use of the datapath between the communication link corresponding to the first port controller and the communication link corresponding to each of the one or more second port controllers.

In one exemplary embodiment, the first port controller and the one or more second port controllers are part of a System of a Chip (SoC), the communication links coupled to the first port controller and the one or more second port controllers comprise a Peripheral Component Interconnect Express (PCIe) communication link, the first power state comprises an L1.0, an L1.1 or an L1.2 power state, and the second power state comprises an L0 power state.

In one exemplary embodiment, the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.

Some exemplary embodiments provide an article of manufacture comprising a non-transitory computer-readable storage medium having stored thereon computer-readable instructions that, when executed by a computer-type device, results in a method to select a datapath through a meshed Input/Output (IO) fabric comprising: detecting at a first port controller a transition from a first power state to a second power state of a communication link coupled to the port controller in which the first power state is a lower power state than the second power state; and determining in response to the detection of the transition of the communication link from the first power state to the second power state one or more second port controllers to be notified to control transition of a communication link coupled to the one or more second controllers from the first power state to the second power state.

### BRIEF DESCRIPTION OF THE DRAWINGS

Example embodiments will be more clearly understood from the following detailed description taken in conjunction with the accompanying drawings. The Figures represent non-limiting, example embodiments as described herein.

FIG. 1 depicts a conventional hierarchical PCIe topology in which a Host is coupled to two devices A and B through a PCIe switch;

FIG. 2 depicts an exemplary embodiment of a meshed IO fabric for a System on Chip (SoC) comprising identical components that may perform individually-differentiated operations under software control;

FIG. 3 depicts a portion of an exemplary embodiment of a meshed IO fabric according to the subject matter disclosed herein;

FIGS. 4A and 4B respectively depict an exemplary embodiment of a wake-up configuration for SoC B of FIG. 2 and a corresponding wake_link signal control table for a situation in which SoC C requests access to the SSD attached to SoC G according to the subject matter disclosed herein;

FIG. 5 depicts a situation in which both SoC C and SoC X of meshed IO fabric require access to the SSD that is coupled to SoC G according to the subject matter disclosed herein;

FIGS. 6A and 6B respectively depict an exemplary embodiment of a wake-up configuration for SoC G of FIG. 5 and a corresponding wake_link signal control table for a situation in which SoC C and SoC X both request access to the SSD attached to SoC G according to the subject matter disclosed herein;

FIG. 7 depicts an exemplary arrangement of system components of a System on a Chip (SoC) that utilizes one or more of the systems and/or techniques disclosed herein to provide a fast link wake-up in a meshed IO fabric;

FIG. 8 depicts an electronic device that utilizes one or more of the systems and/or techniques disclosed herein to provide a fast link wake-up in a meshed IO fabric;

FIG. 9 depicts a memory system that utilizes one or more of the systems and/or techniques disclosed herein to provide a fast link wake-up in a meshed IO fabric;

FIG. 10 depicts a block diagram illustrating an exemplary mobile device that utilizes one or more of the systems and/or techniques disclosed herein to provide a fast link wake-up in a meshed IO fabric;

FIG. 11 depicts a block diagram illustrating a computing system that utilizes one or more of the systems and/or techniques disclosed herein to provide a fast link wake-up in a meshed IO fabric; and

FIG. 12 depicts an exemplary embodiment of an article of manufacture comprising a non-transitory computer-readable storage medium having stored thereon computer-readable instructions that, when executed by a computer-type device, results in any of the various techniques and methods to provide a fast link wake-up in a meshed IO fabric according to the subject matter disclosed herein.

### DESCRIPTION OF EMBODIMENTS

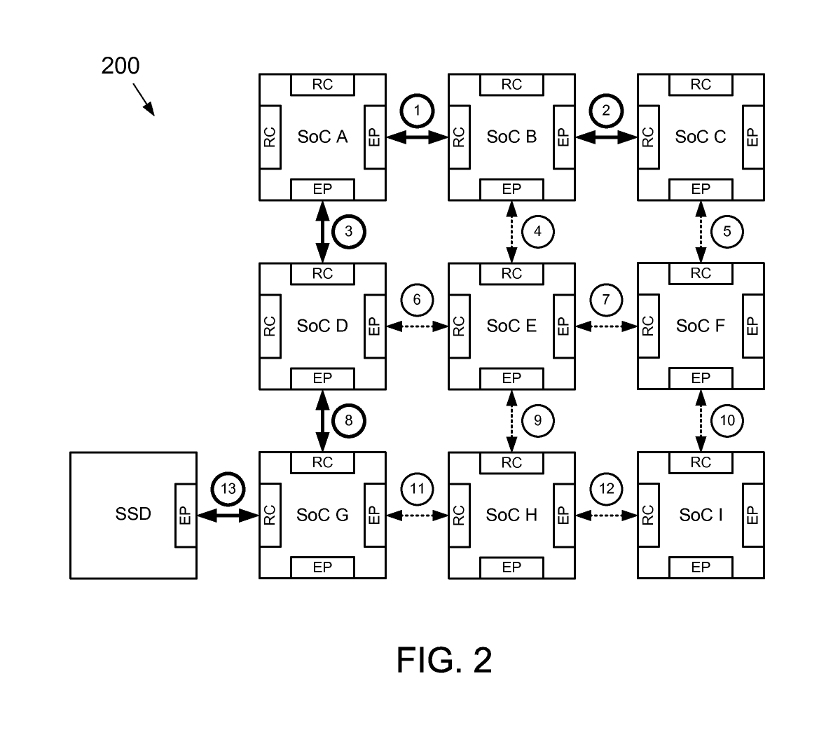

The subject disclosed herein relates a system and a method to select a datapath through a meshed Input/Output (IO) fabric. In one exemplary embodiment, a plurality of port controllers is coupled to interconnection logic. Each port controller is coupled to a corresponding communication link and outputs a detection signal if the corresponding communication link transitions from a first lower-power state to a second higher power state. The interconnection logic, responsive to the detection signal, is configured to output a first signal to one or more selected port controllers to transition the corresponding communication link coupled to the selected port controller from the first power state to the second power state based on a frequency of use of a datapath between the communication link corresponding to the port controller outputting the detection signal and the communication link corresponding to each of the one or more selected port controllers. Exemplary embodiments will typically be utilized in a large system in which multiple components are interconnected and in which a dataflow would involve crossing multiple components of functional blocks that are independently power managed, and a transition from a low-power state to a normal-powered (mission-mode) state takes a considerable amount of time (i.e., comparable to the propagation time of multiple transactions through an interconnect). Such an exemplary system may comprise multiple SOCs, such as depicted in FIG. 2, or be one large SOC comprising multiple functional blocks connected by on-chip fabric.

Various exemplary embodiments will be described more fully hereinafter with reference to the accompanying drawings, in which some exemplary embodiments are shown. As used herein, the word “exemplary” means “serving as an example, instance, or illustration.” Any embodiment described herein as “exemplary” is not to be construed as necessarily preferred or advantageous over other embodiments. The subject matter disclosed herein may, however, be embodied in many different forms and should not be construed as limited to the exemplary embodiments set forth herein. Rather, the exemplary embodiments are provided so that this description will be thorough and complete, and will fully convey the scope of the claimed subject matter to those skilled in the art. In the drawings, the sizes and relative sizes of layers and regions may be exaggerated for clarity.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

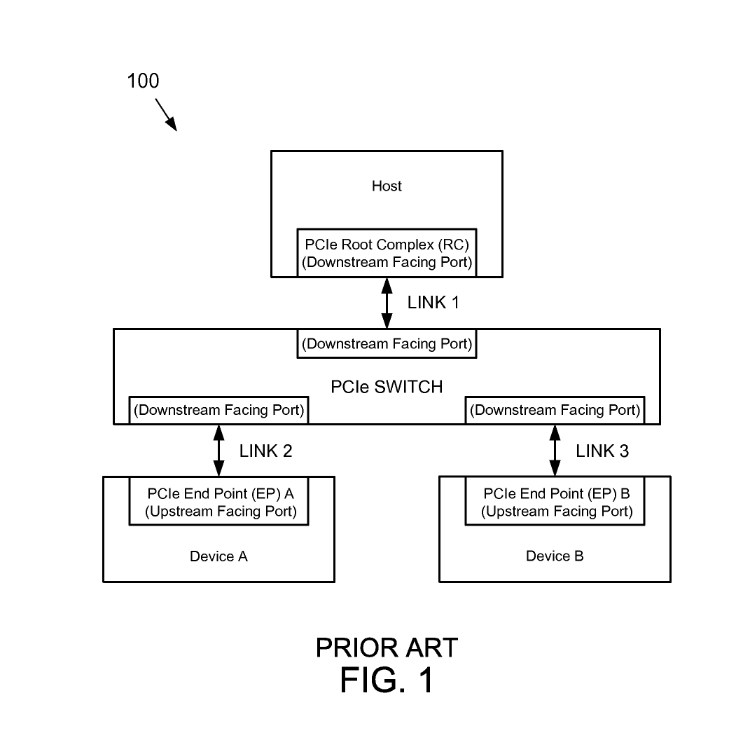

FIG. 1 depicts a conventional hierarchical PCIe topology 100 in which a Host is coupled to two devices A and B through a PCIe switch. As depicted in FIG. 1, the Host is connected to the PCIe switch through a Link 1. Device A is connected to the PCIe switch through a Link 2, and Device B is connected to the PCIe switch through a Link 3. If Links 1 and 2 are in a power state that is lower than the L0 power state (i.e. are in a L1.0, L1.1 or L1.2 power state), in order for Device A to communicate with the Host, the PCI End Point A (EP A) of Device A must transition Link 2 to the L0 power state. Upon sensing the transition of Link 2 to the L0 power state, the PCIe switch begins to transition the power state of Link 1 to the L0 power state to avoid the transmission from Device A to the Host from experiencing two sequential link transitions to the L0 power state—the transition of Link 2 and then the transition of Link 1.

It should be noted that in a conventional PCIe hierarchy shown in FIG. 1, there is only one PCIe Root Complex (RC), which is located within the Host. Conventional PCIe switch designs naturally assume this, thereby simplifying their logic. Moreover, a single Root Complex (RC) and multiple End Points (EPs), like the topology depicted in FIG. 1, form an asymmetric-connectivity scheme on which conventional PCIe switch designs are also based, thereby further simplifying the internal logic of a PCIe switch.

FIG. 2 depicts an exemplary embodiment of a meshed IO fabric 200 for a plurality of Systems on Chip (SoCs) comprising identical components that may perform individually-differentiated operations under software control. Meshed IO fabric 200 comprises SoC A-SoC I, and PCIe links 1-12 (indicated by link numbers in circles) that interconnect SoC A-SoC I. Additionally, meshed IO fabric 200 may include, for example, a Solid-State Drive (SSD) and a PCIe link 13 between SoC G and the SSD. In another exemplary embodiment, SoC G could be coupled to an Ethernet Network Controller or any other PCIe device. Each PCIe link 1-13 includes a PCIe port controller at each end of the link in which one port controller is an End Point (EP) and one port controller is a Root Complex (RC). Whether a port controller is an EP or an RC is arbitrary for meshed IO fabric 200.

One purpose of meshed IO fabric 200 is for one SoC to have access to and share an I/O resource that is attached to another SoC. That is, datapaths through meshed IO fabric 200 can comprise multiple hops from a data source to a destination. Data traffic through the various links of meshed IO fabric 200 is typically not symmetrical or balanced, and some links may be heavily used while others may be idle or unused for long periods of time. Although each link in meshed IO fabric 200 is terminated with an EP and an RC, the topology of meshed IO fabric 200 is significantly different that the hierarchal PCIe configuration depicted in FIG. 1 because meshed IO fabric 200 comprises multiple RC ports that comprise multiple independent PCIe networks that conventional PCIe switches are not designed to handle. For example, the PCIe standard does not define a mechanism to propagate wake-up information beyond an RC. Additionally, the PCIe standard does not provide a technique to determine which datapaths of a multi-datapath configuration should wake up and transition to the L0 power state. Waking all links would use too much power and waking up each controller along on a datapath when the controller receives a packet in accordance with the PCIe standard would be slow, and each link would need to retrain, which would take an excessive amount of time. In contrast to a standard PCIe approach, SoC A-SoC I within mesh IO fabric 200 perform switching and routing rather than using a standard PCIe mechanism.

In FIG. 2, suppose that SoC C requires access to the SSD that is attached to SoC G. One way to achieve this would be to generate a packetized request at SoC C and transfer it to SoC B over Link 2. Using internal logic and preconfigured logic, SoC B could forward the request packet to SoC A over Link 1, which then forwards it to SoC D over Link 3. SoC D would then forward the request packet to SoC G over Link 8 for presentation to the SSD over link 13. A response from the SSD to SoC C might, but not necessarily, follow that same traversal path in reverse.

A traversal process through meshed IO fabric 200 regardless of direction causes routing activity within every SoC through which the communication travels. More importantly, each path link—Links 2, 1, 3, 8 and 13—may be in a power state that is lower than power state L0, so a wake-up process must be performed. With a conventional PCIe wake-up approach, communication transfers between SoC C and the SSD may require as many as five sequential transitions from a lower-power state to the L0 Power state. The multiple transitions collectively reduce the performance of SoC C performance because the transitions occur sequentially, one after another, and can also collectively preclude SoC C from meeting a Quality of Service (QOS) service guarantee associated with SoC C.

The subject matter disclosed herein provides an approach that eliminates power-state transition delays in a meshed IO fabric like meshed IO fabric 200 by providing a new wake_link signal within connecting SoCs. The wake_link signal provides a RC (or an EP) a notification from another independent RC (or EP) that the link associated with the notified RC (or EP) may require a transition to the L0 power state. In one exemplary embodiment, each PCIe RC or EP port within an SoC includes a wake_link signal that is routed to other PCIe RC or EP ports within the SoC. If a PCIe port detects a transition of a link to the L0 power state, the port notifies other PCIe ports within the SoC of the detected transition using a wake_link signal. A link coupled to a notified port then transition to the L0 state, thereby reducing the latency associated with the datapath.

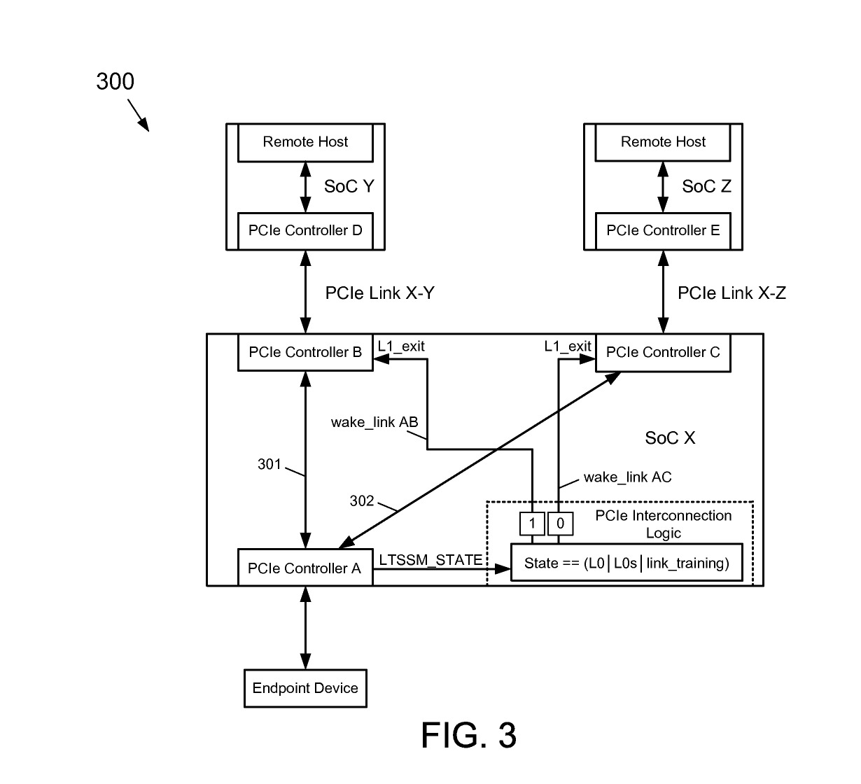

FIG. 3 depicts a portion of an exemplary embodiment of a meshed IO fabric 300 according to the subject matter disclosed herein. The portion of meshed IO fabric 300 depicted in FIG. 3 comprises an SoC X that is respectively coupled to an SoC Y and an SoC Z over PCIe link X-Y and PCIe link X-Z. Additionally, SoC X is coupled to an Endpoint Device through a PCIe link EP-X. Endpoint device could comprise, but is not limited to, a Solid-State Drive (SSD), an Ethernet Network Controller, or any other PCIe device.

SoC X comprises PCIe port controllers A-C and PCIe interconnection logic. PCIe port controller A of SoC X interfaces PCIe port controller B and to PCIe controller C through on-chip datapaths 301 and 302. SoC Y represents a Remote Host with PCIe port controller D. Similarly, SoC Z is a Remote Host with PCIe port controller E. For each of SoC X-SoC Z, whether a port controller is an EP or an RC is arbitrary. It should be understood that SoCs X-Z could comprise more components and additional internal connections that are not depicted in FIG. 3.

If, for example, a PCIe port controller of an SoC detects a transition of the link from L1.x power state, the interconnection logic notifies some of the other PCIe port controllers within the SoC of the transition using a wake_link signal. In one exemplary embodiment, PCIe Interconnection Logic detects a transition of the link between SoC X and the Endpoint device from L1.x state based on the Link Training and Status State Machine (LTSSM) state output by PCIe Controller A. In one exemplary embodiment, SoC X detects a transition of the link between SoC X and the Endpoint device if the link transition from the L1.0, the L1.1, or the L1.2 power states to the L0 power state.

The PCIe interconnection logic determines which other port controller(s) within SoC X is/are notified and outputs a wake_link signal to the particular port controller(s) that are associated with a link that may require a transition to the L0 power state. Notification of a port controller is controlled by the information in a wake_link signal control table. A wake_link signal control table is initialized by a system management function using one of many well-known techniques such as, but not limited to, SoC-to-SoC information propagation or individual SoC serial EPROM information data. In one exemplary embodiment, determination of which particular port controller(s) is/are notified is based on a frequency in which a corresponding datapath/link is used.

A wake_link signal from the PCIe interconnection logic is an input to each PCIe Controller, triggering an exit from L1.x state. As shown in FIG. 3, a wake_link AB signal is coupled from the PCIe interconnection logic of Controller A to port controller B for link wake ups initiated by port controller A in which the wake_link signal control table indicates that port controller B should be notified. Similarly, a wake_link AC signal is coupled from the PCIe interconnection logic of Port Controller A to port controller C for wake ups initiated by port controller A in which the wake_link signal control table indicates that port controller C should be notified.

Although not shown in FIG. 3, port controllers B and C of SoC X output their LTSSM state_to the PCIe interconnection logic, which generates corresponding wake_link signals to the other port controllers within SoC X. Additionally, exemplary embodiments of SoC X may comprise a datapath between port controller B and port controller C that is not shown in FIG. 3. Further, in some exemplary embodiments, the signals and/or functionality described for the various port controllers of SoC X does not necessarily extend to every port controller of SoC X.

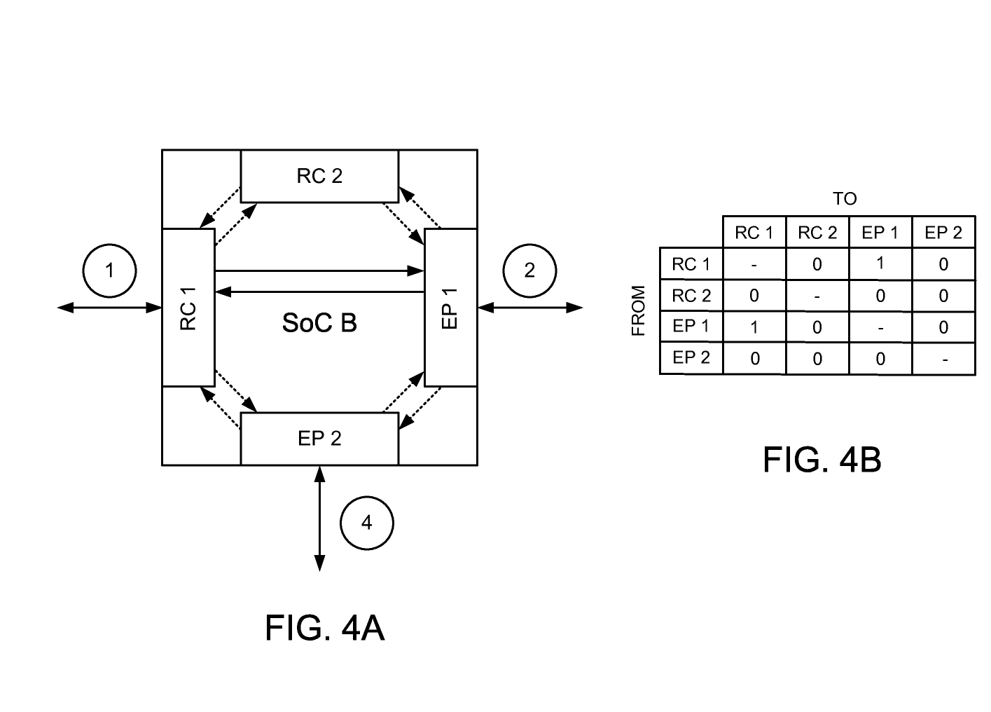

FIGS. 4A and 4B respectively depict an exemplary embodiment of a wake-up configuration for SoC B of FIG. 2 and a corresponding wake_link signal control table for a situation in which SoC C requests access to the SSD attached to SoC G according to the subject matter disclosed herein. When Link 2 between SoC C and SoC B transitions to the L0 power state, SoC B should also transition Link 1 to the L0 power state. In FIG. 4A, datapaths through SoC B that are indicated with solid lines are enabled, and datapaths that are indicated with dotted lines are disabled. In the wake_link signal control table of FIG. 4B, a “1” indicates frequently used datapath and a “0” indicates a datapath that is not frequently used or is disabled. For this situation, if EP 1 detects a transition of Link 2 to the L0 power state and, based on the wake_link signal control table for SoC B, EP 1 notifies RC 1 so that RC 1 transitions Link 1 to the L0 power state. Also, if RC 1 detects a transition of Link 1 to the L0 power state and, based on the wake_link signal control table for SoC B, RC 1 notifies EP 1 so that EP 1 transitions Link 2 to the L0 power state. For this exemplary embodiment, the wake_link signal control table of FIG. 4B was initialized based on a prior selection or determination, such as by design, that the datapath from SoC C to the SSD would follow Links 2, 1, 3, 8 and 13, and the datapath from the SSD to SoC C would follow Links 13, 8, 3, land 2.

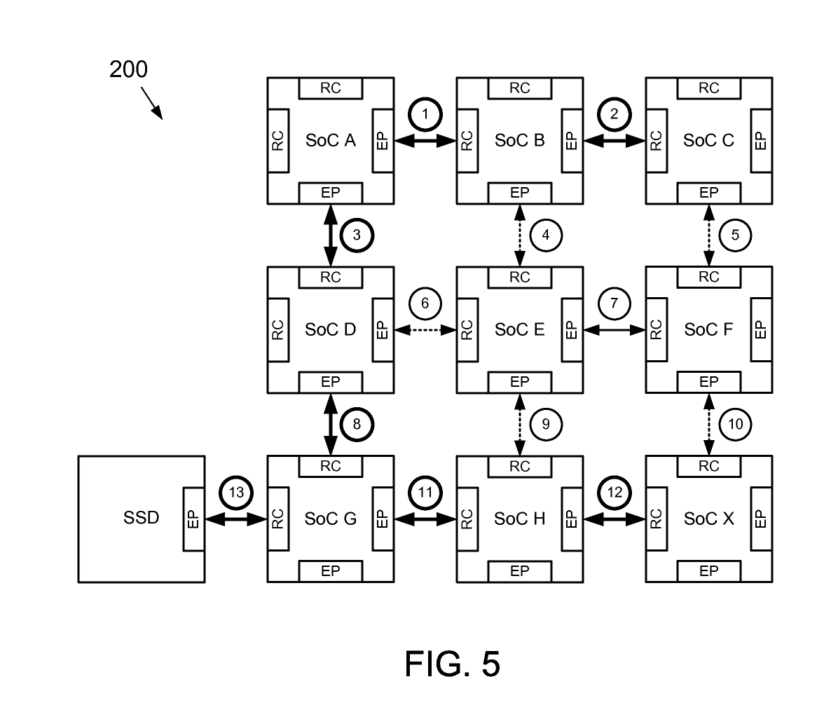

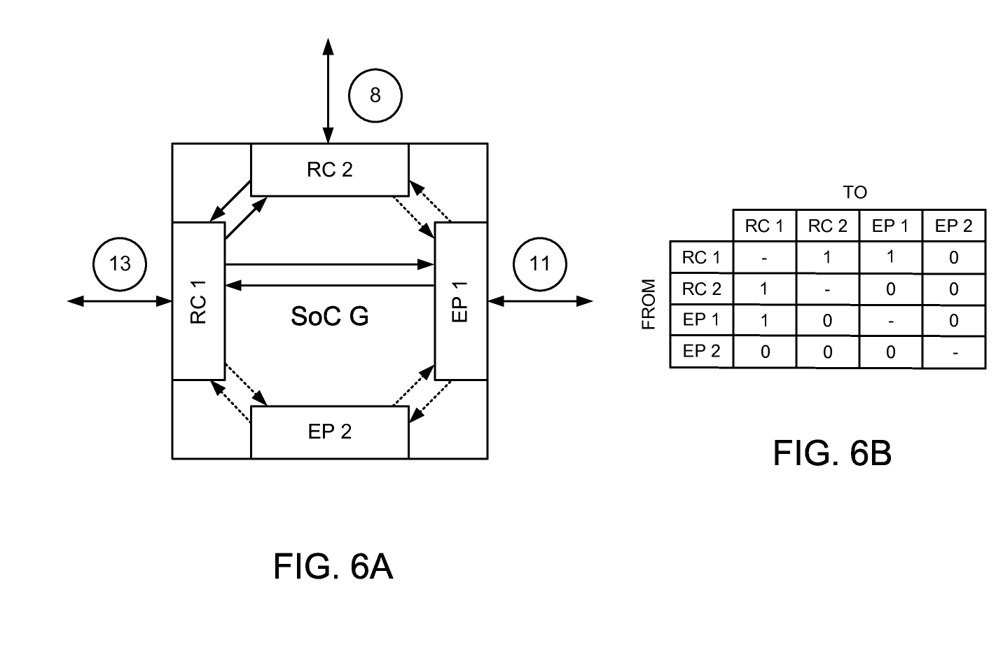

FIG. 5 depicts a situation in which both SoC C and SoC X of meshed IO fabric 200 require access to the SSD that is coupled to SoC G according to the subject matter disclosed herein. In this situation, the data transfers traverse Links 13, 8, 3, 1 and 2, and Links 13, 11 and 12. That is, when the SSD transmits data on Link 13, the data sometimes goes to Link 8 and onward to SoC C, and sometimes goes to Link 11 and onward to SoC X. FIGS. 6A and 6B respectively depict an exemplary embodiment of a wake-up configuration for SoC G of FIG. 5 and a corresponding wake_link signal control table for a situation in which SoC C and SoC X both request access to the SSD attached to SoC G according to the subject matter disclosed herein. In FIG. 6A, datapaths indicated with solid lines are enabled, and datapaths indicated with dotted lines are disabled. In the wake_link signal control table of FIG. 6B, a “1” indicates an enabled/frequently used datapath and a “0” indicates a disabled or unused datapath. For this situation of FIG. 5, if RC 1 of SoC G detects a transition of Link 13 to the L0 power state, based on the information in the wake_link signal control table for SoC G, RC 1 notifies RC 2 so that RC 1 transitions Link 8 to the L0 power state, and notifies EP 1 so that EP 1 transitions Link 11 to the L0 power state.

When low-power state exit is initiated on PCIe Link 13 of SoC G, both Links 8 and 11 are transitioned to the L0 power state. As Links 8 and 11 transition to the L0 power state, PCIe Controllers on the other side of the link detect the transition and, based on the wake_link signal control tables contained in the corresponding SoC, transition the corresponding intermediary links to SoC C and SoC X to the L0 power state. While this causes some links to unnecessarily transition to the L0 power state, the electrical cost is negligible because the links remain briefly inactive and rapidly transition to a lower-power state. The wake_signal, however, enables all hops on the path used to transfer data to the destination SoC to transition essentially simultaneously, thereby removing the performance penalty of sequentially powering up a plurality of links in accordance with the PCIe standard. This enables separate PCIe links along a multi-hop datapath to benefit from the sustained throughput performance that is similar to a single PCIe link. Moreover, as soon as a link is detect to be transitioning from the L1.x power state to the L0 power state, the next link in the datapath can be notified to transition to the L0 power state without waiting for the first link to completely transition to the L0 power state.

Additionally, although exemplary embodiments disclosed herein describe the communication links as being PCIe communication links, it should be understood that the subject matter disclosed herein is not so limited and the communication links could comprise high-speed communication links that operate under another communication standard.

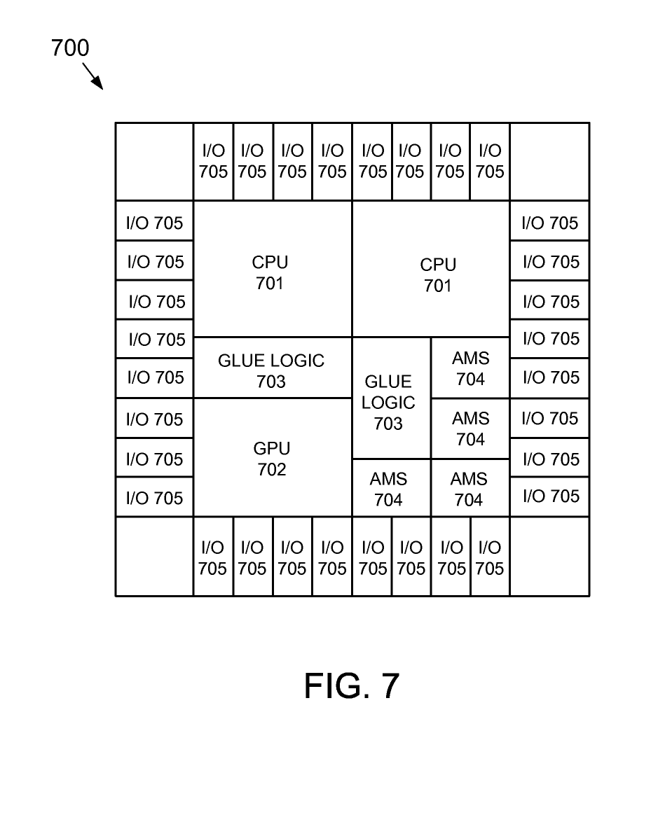

FIG. 7 depicts an exemplary arrangement of system components of a System on a Chip (SoC) 700 that utilizes one or more of the systems and/or techniques disclosed herein to provide a fast link wake-up in a meshed IO fabric. The exemplary arrangement of SoC 700 comprises one or more central processing units (CPUs) 701, one or more graphical processing units (GPUs) 702, one or more areas of glue logic 703, which can include PCIe interconnection logic and wake_link signal control tables according to embodiments disclosed herein, one or more analog/mixed signal (AMS) areas 705, and one or more Input/Output (I/O) areas 705. It should be understood that other arrangements of SoC 700 are possible and that SoC 700 could comprise other system components than those depicted in FIG. 7. SoC 700, which may utilize one or more of the systems and/or techniques disclosed herein to provide a fast link wake-up in an meshed IO fabric, and may be used in various types of electronic devices, such as, but not limited to, a server system, a computing device, a personal digital assistant (PDA), a laptop computer, a mobile computer, a web tablet, a wireless phone, a cell phone, a smart phone, a digital music player, or a wireline or wireless electronic device.

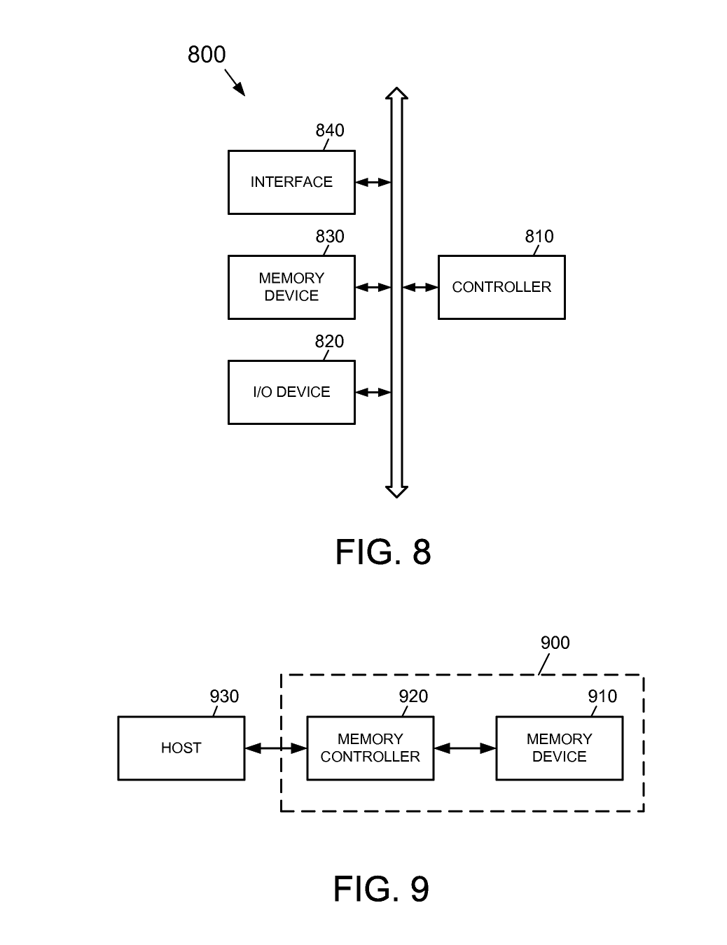

FIG. 8, for example, depicts an electronic device 800 that utilizes one or more of the systems and/or techniques disclosed herein to provide a fast link wake-up in a meshed IO fabric. Electronic device 800 may be used in, but not limited to, a computing device, a server system, a personal digital assistant (PDA), a laptop computer, a mobile computer, a web tablet, a wireless phone, a cell phone, a smart phone, a digital music player, or a wireline or wireless electronic device. The electronic device 800 may comprise a controller 810, an input/output device 820 such as, but not limited to, a keypad, a keyboard, a display, or a touch-screen display, a memory 830, and a wireless interface 840 that are coupled to each other through a bus 850. The controller 810 may comprise, for example, at least one microprocessor, at least one digital signal process, at least one microcontroller, or the like. The memory 830 may be configured to store a command code to be used by the controller 810 or a user data. The electronic device 800 may use a wireless interface 840 configured to transmit data to or receive data from a wireless communication network using a RF signal. The wireless interface 840 may include, for example, an antenna, a wireless transceiver and so on. The electronic system 800 may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service—Time Division Duplex (UMTS-TDD), High Speed Packet Access (HSPA), Evolution Data Optimized (EVDO), Long Term Evolution—Advanced (LTE-Advanced), Multichannel Multipoint Distribution Service (MMDS), and so forth.

FIG. 9 depicts a memory system 900 that utilizes one or more of the systems and/or techniques disclosed herein to provide a fast link wake-up in a meshed IO fabric. The memory system 900 may comprise a memory device 910 for storing large amounts of data and a memory controller 920. The memory controller 920 controls the memory device 910 to read data stored in the memory device 910 or to write data into the memory device 910 in response to a read/write request of a host 930. The memory controller 930 may include an address-mapping table for mapping an address provided from the host 930 (e.g., a mobile device or a computer system) into a physical address of the memory device 910.

The exemplary SoCs disclosed herein may be encapsulated using various and diverse packaging techniques. For example, the SoCs disclosed herein may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic quad flat package (PQFP) technique, a thin quad flat package (TQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique and a wafer-level processed stack package (WSP) technique.

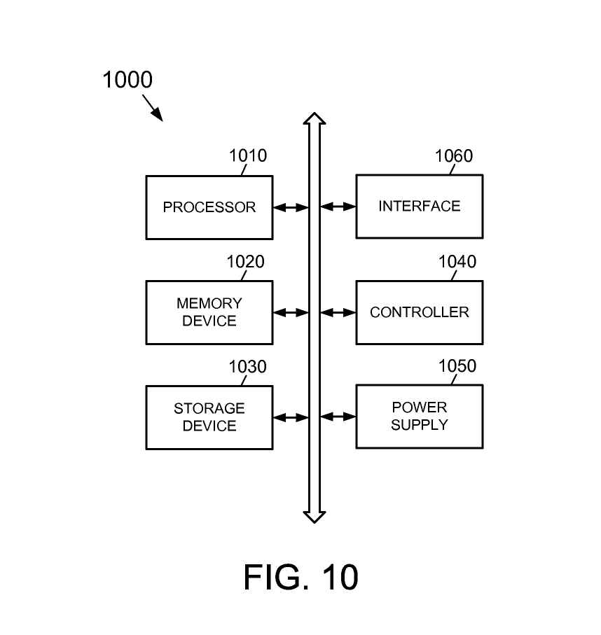

FIG. 10 depicts a block diagram illustrating an exemplary mobile device 1000 that utilizes one or more of the systems and/or techniques disclosed herein to provide a fast link wake-up in a meshed IO fabric. Referring to FIG. 10, a mobile device 1000 may comprise a processor 1010, a memory device 1020, a storage device 1030, a display device 1040, a power supply 1050 and an image sensor 1060. The mobile device 1000 may further comprise ports that communicate with a video card, a sound card, a memory card, a USB device, other electronic devices, etc.

The processor 1010 may perform various calculations or tasks. According to exemplary embodiments, the processor 1010 may be a microprocessor or a CPU. The processor 1010 may communicate with the memory device 1020, the storage device 1030, and the display device 1040 via an address bus, a control bus, and/or a data bus. In some exemplary embodiments, the processor 1010 may be coupled to an extended bus, such as a peripheral component interconnection (PCI) bus or a PCI Express (PCIe) bus. The memory device 1020 may store data for operating the mobile device 1000. For example, the memory device 1020 may be implemented with, but is not limited to, a dynamic random access memory (DRAM) device, a mobile DRAM device, a static random access memory (SRAM) device, a phase-change random access memory (PRAM) device, a ferroelectric random access memory (FRAM) device, a resistive random access memory (RRAM) device, and/or a magnetic random access memory (MRAM) device. The memory device 1020 comprises a magnetic random access memory (MRAM) according to exemplary embodiments disclosed herein. The storage device 1030 may comprise a solid-state drive (SSD), a hard disk drive (HDD), a CD-ROM, etc. The display device 1040 may comprise a touch-screen display. The mobile device 1000 may further include an input device (not shown), such as a touchscreen different from display device 1040, a keyboard, a keypad, a mouse, etc., and an output device, such as a printer, a display device, etc. The power supply 1050 supplies operation voltages for the mobile device 1000.

The image sensor 1060 may communicate with the processor 1010 via the buses or other communication links. The image sensor 1060 may be integrated with the processor 1010 in one chip, or the image sensor 1060 and the processor 1010 may be implemented as separate chips.

At least a portion of the mobile device 1000 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP). The mobile device 1000 may be a digital camera, a mobile phone, a smart phone, a portable multimedia player (PMP), a personal digital assistant (PDA), a computer, a tablet, etc.

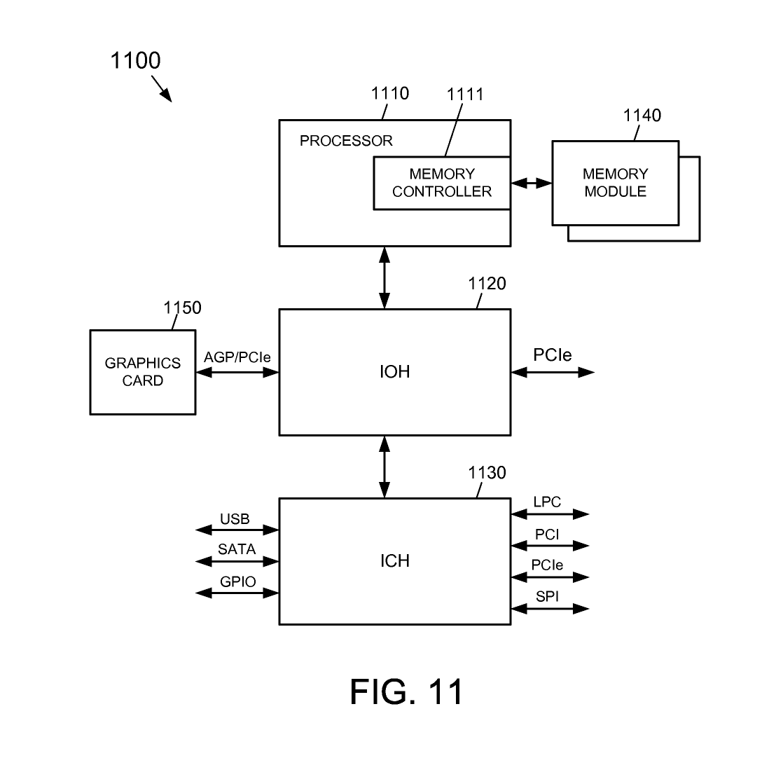

FIG. 11 depicts a block diagram illustrating a computing system 1100 that utilizes one or more of the systems and/or techniques disclosed herein to provide a fast link wake-up in a meshed IO fabric. Referring to FIG. 11, a computing system 1100 comprises a processor 1110, an input/output hub (IOH) 1120, an input/output controller hub (ICH) 1130, at least one memory module 1140 and a graphics card 1150. In some exemplary embodiments, the computing system 1100 may comprise a server system, a personal computer (PC), a server computer, a workstation, a laptop computer, a mobile phone, a smart phone, a personal digital assistant (PDA), a portable multimedia player (PMP), a digital camera), a digital television, a set-top box, a music player, a portable game console, a navigation system, etc.

The processor 1110 may perform various computing functions, such as executing specific software for performing specific calculations or tasks. For example, the processor 1110 may comprise a microprocessor, a central process unit (CPU), a digital signal processor, or the like. In some embodiments, the processor 1110 may include a single core or multiple cores. For example, the processor 1110 may be a multi-core processor, such as a dual-core processor, a quad-core processor, a hexa-core processor, etc. In some embodiments, the computing system 1100 may comprise a plurality of processors. The processor 1110 may comprise an internal or external cache memory.

The processor 1110 may include a memory controller 1111 for controlling operations of the memory module 1140. The memory controller 1111 included in the processor 1110 may be referred to as an integrated memory controller (IMC). A memory interface between the memory controller 1111 and the memory module 1140 may be implemented with a single channel including a plurality of signal lines, or may bay be implemented with multiple channels, to each of which at least one memory module 1140 may be coupled. In some embodiments, the memory controller 1111 may be located inside the input/output hub 1120, which may be referred to as memory controller hub (MCH).

The input/output hub (IOH) 1120 may manage data transfer between processor 1110 and devices, such as the graphics card 1150. The input/output hub 1120 may be coupled to the processor 1110 via various interfaces. For example, the interface between the processor 1110 and the input/output hub 1120 may be a front side bus (FSB), a system bus, a HyperTransport, a lightning data transport (LDT), a QuickPath interconnect (QPI), a common system interface (CSI), etc. In some exemplary embodiments, the computing system 1100 may comprise a plurality of input/output hubs. The input/output hub 1120 may provide various interfaces with the devices. For example, the input/output hub 1120 may provide an accelerated graphics port (AGP) interface, a peripheral component interface-express (PCIe), a communications streaming architecture (CSA) interface, etc.

The graphics card 1150 may be coupled to the input/output hub 1120 via AGP or PCIe. The graphics card 1150 may control a display device (not shown) for displaying an image. The graphics card 1150 may include an internal processor for processing image data and an internal memory device. In some embodiments, the input/output hub 1120 may include an internal graphics device along with or instead of the graphics card 1150 outside the graphics card 1150. The graphics device included in the input/output hub 1120 may be referred to as integrated graphics. Further, the input/output hub 1120 including the internal memory controller and the internal graphics device may be referred to as a graphics and memory controller hub (GMCH).

The input/output controller hub (ICH) 1130 may perform data buffering and interface arbitration to efficiently operate various system interfaces. The input/output controller hub 1130 may be coupled to the input/output hub 1120 via an internal bus, such as a direct media interface (DMI), a hub interface, an enterprise Southbridge interface (ESI), PCIe, etc. The input/output controller hub 1130 may provide various interfaces with peripheral devices. For example, the input/output controller hub 1130 may provide a universal serial bus (USB) port, a serial advanced technology attachment (SATA) port, a general purpose input/output (GPIO), a low pin count (LPC) bus, a serial peripheral interface (SPI), PCI, PCIe, etc.

In some exemplary embodiments, the processor 1110, the input/output hub 1120 and the input/output controller hub 1130 may be implemented as separate chipsets or separate integrated circuits. In other exemplary embodiments, at least two of the processor 1110, the input/output hub 1120 and the input/output controller hub 1130 may be implemented as a single chipset.

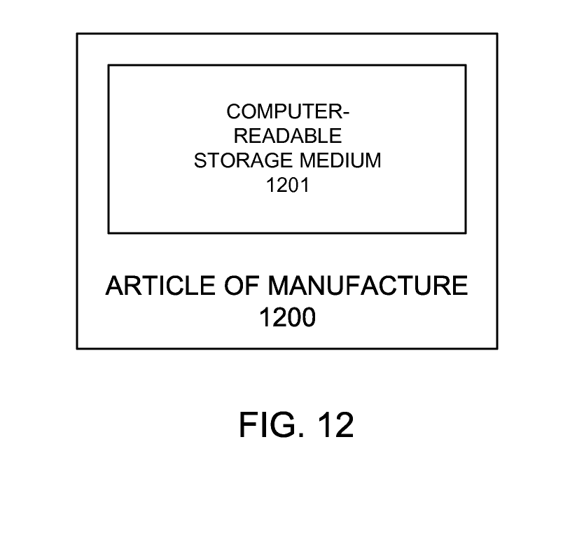

FIG. 12 depicts an exemplary embodiment of an article of manufacture 1200 comprising a non-transitory computer-readable storage medium 1201 having stored thereon computer-readable instructions that, when executed by a computer-type device, results in any of the various techniques and methods to provide a fast link wake-up in a meshed IO fabric according to the subject matter disclosed herein. Exemplary computer-readable storage mediums that could be used for computer-readable storage medium 1201 could be, but are not limited to, a semiconductor-based memory, an optically based memory, a magnetic-based memory, or a combination thereof.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the subject matter disclosed herein. Accordingly, all such modifications are intended to be included within the scope of the appended claims.

What is claimed is:

1. A System on a Chip (SoC), comprising:
a plurality of port controllers, each port controller being coupled to a corresponding communication link and each port controller being configured to output a detection signal if the corresponding communication link transitions from a first power state to a second power state, the first power state being a lower power state than the second power state; and
interconnection logic coupled to each port controller, the interconnection logic being configured to be responsive to the detection signal of each port controller by outputting a wake-up signal to one or more selected port controllers to transition the corresponding communication link coupled to the selected port controller from the first power state to the second power state.

2. The SoC according to claim 1, wherein the one or more selected port controllers are selected based on a datapath between the communication link corresponding to the port controller outputting the detection signal and the communication link corresponding to each of the one or more selected port controllers.

3. The SoC according to claim 2, wherein the one or more selected port controllers are selected based on a frequency of use of the datapath between the communication link corresponding to the port controller outputting the detection signal and the communication link corresponding to each of the one or more selected port controllers.

4. The SoC according to claim 2, wherein the interconnection logic comprises a table containing information relating to the datapath for selecting the one or more port controllers.

5. The SoC according to claim 2, wherein the communication link coupled to at least one port controller comprises a Peripheral Component Interconnect Express (PCIe) communication link.

6. The SoC according to claim 5, wherein the first power state comprises an L1.0, an L1.1 or an L1.2 power state, and
wherein the second power state comprises an L0 power state.

7. The SoC according to claim 5, wherein each port controller comprises a Root Complex (RC) or an End Point (EP).

8. The SoC according to claim 1, wherein the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.

9. A system, comprising:
a plurality of communication links, one or more of the communication links comprising a first power state and a second power state, the first power state being a lower power state than the second power state, and the one or more communication links transitioning from the first power state to the second power state to transport data over the communication link; and
a plurality of Systems of a Chip (SoCs) interconnected by the plurality of communication links, each SoC comprising:
at least two port controllers, each port controller being coupled to a corresponding communication link and the at least two port controllers being configured to output a detection signal if the corresponding communication link transitions from the first power state to the second power state; and
interconnection logic coupled to at least one of the two port controllers, the interconnection logic being configured to be responsive to the detection signal of the at least two port controllers by outputting a first signal to one or more selected port controllers to transition the corresponding communication link coupled to the selected port controller from the first power state to the second power state.

10. The system according to claim 9, wherein the one or more selected port controllers are selected based on a datapath between the communication link corresponding to the port controller outputting the detection signal and the communication link corresponding to each of the one or more selected port controllers.

11. The system according to claim 10, wherein the one or more selected port controllers are selected based on a frequency of use of the datapath between the communication link corresponding to the port controller outputting the detection signal and the communication link corresponding to each of the one or more selected port controllers.

12. The system according to claim 10, wherein the interconnection logic comprises a table containing information relating to the datapath for selecting the one or more port controllers.

13. The system according to claim 10, wherein the communication link coupled to at least one port controller comprises a Peripheral Component Interconnect Express (PCIe) communication link.

14. The system according to claim 13, wherein the first power state comprises an L1.0, an L1.1 or an L1.2 power state, and
wherein the second power state comprises an L0 power state.

15. The system according to claim 13, wherein each port controller comprises a Root Complex (RC) or an End Point (EP).

16. The system according to claim 9, wherein the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.

17. A method to select a datapath through a meshed Input/Output (IO) fabric, the method comprising:
detecting at a first port controller a transition from a first power state to a second power state of a communication link coupled to the port controller, the first power state being a lower power state than the second power state; and
determining in response to the detection of the transition of the communication link from the first power state to the second power state one or more second port controllers to be notified of the transition of the communication link to the second power state.

18. The method according to claim 17, wherein the one or more second port controllers are determined based on a frequency of use of the datapath between the communication link corresponding to the first port controller and the communication link corresponding to each of the one or more second port controllers.

19. The method according to claim 17, wherein the first port controller and the one or more second port controllers are part of a System of a Chip (SoC),
wherein the communication links coupled to the first port controller and the one or more second port controllers comprise a Peripheral Component Interconnect Express (PCIe) communication link,
wherein the first power state comprises an L1.0, an L1.1 or an L1.2 power state, and
wherein the second power state comprises an L0 power state.

20. The method according to claim 19, wherein the SoC comprises part of a server system, a computing device, a personal digital assistant (PDA), a laptop computer, a mobile computer, a web tablet, a wireless phone, a cell phone, a smart phone, a digital music player, or a wireline or wireless electronic device.
